(19) United States
(12) Patent Application Publication
(10) Pub. No.: US 2007/0222169 A1
(43) Pub. Date: Sep. 27, 2007

(54) Air spring lift kit

(76) Inventors: Aaron M. Smith, Paw Paw, MI (US); Melvin Allen Peacock, Kalamazoo, MI (US); Kent E. Davison, Sturgis, MI (US)

Correspondence Address: MARSHALL & MELHORN, FOUR SEAGATE, EIGHT FLOOR, TOLEDO, OH, 43604, US

(21) Appl. No.: 11/390,406

(22) Filed: Mar. 27, 2006

(51) Int. Cl. B60G 11/27; B60G 9/00

(52) U.S. Cl. 280/124.157; 280/124.116

(57) ABSTRACT

The present invention relates to an air spring lift kit that has a trailing arm with a first end portion that is pivotally connected to a hanger bracket. A horizontally oriented air bag is connected at one end to the hanger bracket and connected at another end to a pivoting lever arm. A link has one end pivotally connected to the lever arm and another end pivotally connected to a flange member that is secured to the trailing arm. A vertically oriented air bag is located between a second end portion of the trailing arm and a frame member of a vehicle, for example, a dump truck or a trailer in a tractor-trailer combination.

### FIELD OF THE INVENTION

The present invention relates to an air spring lift kit. More particularly, the present invention is suited for an air spring lift kit for trucks and/or trailers.

### BACKGROUND OF THE INVENTION

Those skilled in the art know that a vehicle has a suspension for connecting one or more wheels to the frame of the vehicle. In addition, it may be desirable, for example, for dump trucks and for trailers in a tractor-trailer combination to have their vehicle carrying capacity increased. Hence, an additional suspension, or suspensions, may be utilized to increase the carrying capacity of these vehicles. For ease of use and improved vehicle fuel consumption, it has been found that the additional suspension(s) can be lowered into service when needed and, subsequently, lifted from service when not required.

Examples of relevant art involving movable suspensions are as follows. U.S. Pat. No. 3,771,812 and Great Britain Patent No. 1,373,484, both to Lear Siegler, Inc., teach the same device comprising a bracket pivotally connected to the forward end of a control arm. The rear end of the control arm is connected to a vertically oriented air spring, which acts to move the suspension downward when inflated and allows the suspension to retract upward when deflated.

The device further comprises a coil spring having one end attached to the vehicle frame and the other end connected to a lever arm. A chain extends from the lever arm to the axle. When the vehicle is loaded and additional weight carrying capacity is desired, the air spring is inflated. Inflation of the air spring drives the control arm, and thus the axle, which is attached to the control arm, downwardly until the wheels touch the ground. When an operator desires to lift the axle, less air is supplied to the air spring. The spring acts through the lever arm to draw the axle upwardly via the chain.

U.S. Pat. No. 4,634,141 teaches an axle lift mechanism comprising a trailing arm pivotally connected to a bracket that is connected to a vehicle frame. A vertically oriented air bag, which cooperates with an associated axle, is located between the trailing arm and the vehicle frame, toward the end of the trailing arm that is opposite the bracket. One end of a flexible strap is also connected to the trailing arm opposite the connection of the bracket.

A middle portion of the strap is wrapped around a pivoting cam and the other end of the strap is connected to a spring system. The spring system pulls on the strap to urge the trailing arm upwardly. On the other hand, the air bag can be inflated to overcome the spring system and urge the trailing arm, and thus the axle, downwardly.

U.S. Pat. No. 5,058,916 teaches a lift apparatus for a suspension comprising a trailing arm pivotally attached to a frame bracket at one end and having a first vertically oriented air bag attached at the other end of the trailing arm. The first vertically oriented air bag is utilized to move the suspension into a downwardly oriented position. Toward the pivotal connection of the trailing arm with the frame bracket, a cable is attached to the trailing arm. The cable is attached to a second vertically oriented air bag. To raise the suspension, air is provided to the second vertically oriented air bag, which inflates. The second air bag draws the cable upwardly, thus also drawing the trailing arm upwardly. Contemporaneously, air is released from the first vertically oriented air bag to allow the trailing arm to pivot upwardly.

As detailed above, the related art requires various parts that are bulky and in some cases complicated, which tends to add weight and cost. Also, the related art makes assembly and replacement of lifting and lowering mechanisms difficult. Further, the art that utilizes bushings at various pivot points may experience an increase in impact loading and fatigue during transport in the lifted position. Thus, a more reliable, compact, lower weight, and more movable air spring lift kit has been sought.

### SUMMARY OF THE INVENTION

The present invention relates to an air spring lift kit that comprises a trailing arm having an end portion, where the end portion -is pivotally disposed on a hanger bracket; a horizontally oriented air bag that is disposed at one end to the hanger bracket and disposed at another end to a pivoting lever arm; and a link having one end pivotally disposed on the lever arm and another end pivotally disposed on the trailing arm.

Further advantages of the present invention will be apparent from the following description and appended claims, reference being made to the accompanying drawings forming a part of a specification, wherein like reference characters designate corresponding parts of several views.

### BRIEF DESCRIPTION OF THE DRAWINGS

FIG. 1 is a side elevation view of an air spring lift kit in a lowered position in accordance with the present invention;

FIG. 2 is a side elevation view of the air spring lift kit of FIG. 1 in a nominally lifted position with an alternate embodiment of a link;

FIG. 3 is a side elevation view of the air spring lift kit of FIG. 1 in a fully raised position;

FIG. 4 is a three dimensional view to the left of the line 4/6-4/6 of FIG. 3;

FIG. 5 is a three dimensional view in the direction of the line 5-5 of FIG. 3; and

FIG. 6 is the side elevation view to the left of the line 4/6-4/6 of FIG. 3 that also depicts an outboard portion of a hanger bracket.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

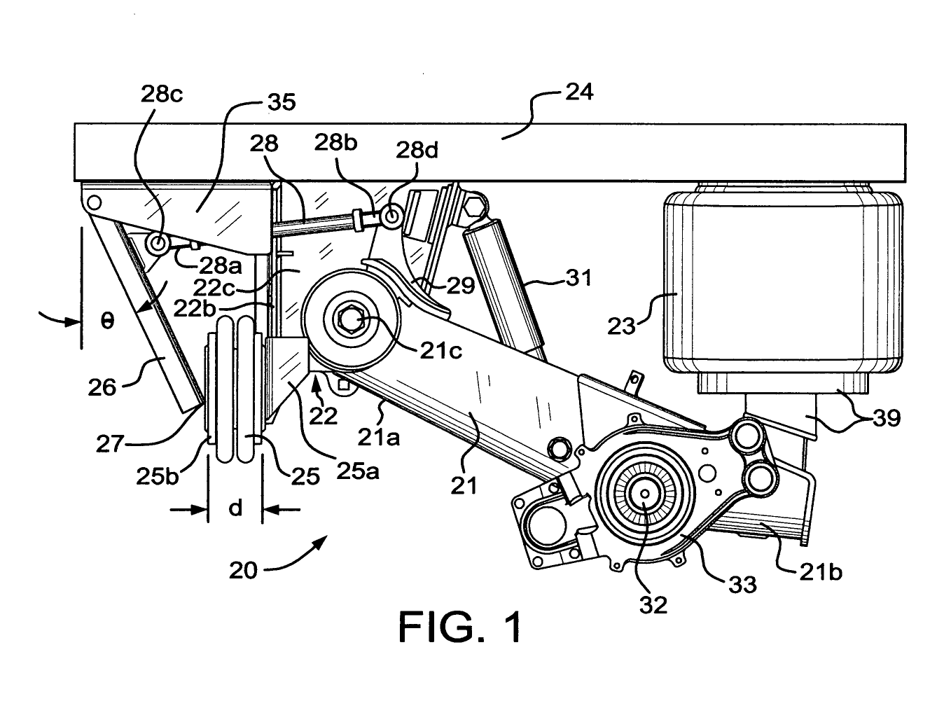

FIG. 1 illustrates an air spring lift kit 20 that is in a lowered position. The air spring lift kit 20 comprises a trailing arm 21 having a first end portion 21a and a second end portion 21b, where the first end portion 21a is pivotally disposed at a trailing arm pivot 21c on a hanger bracket 22 that is disposed on a vehicle frame 24.

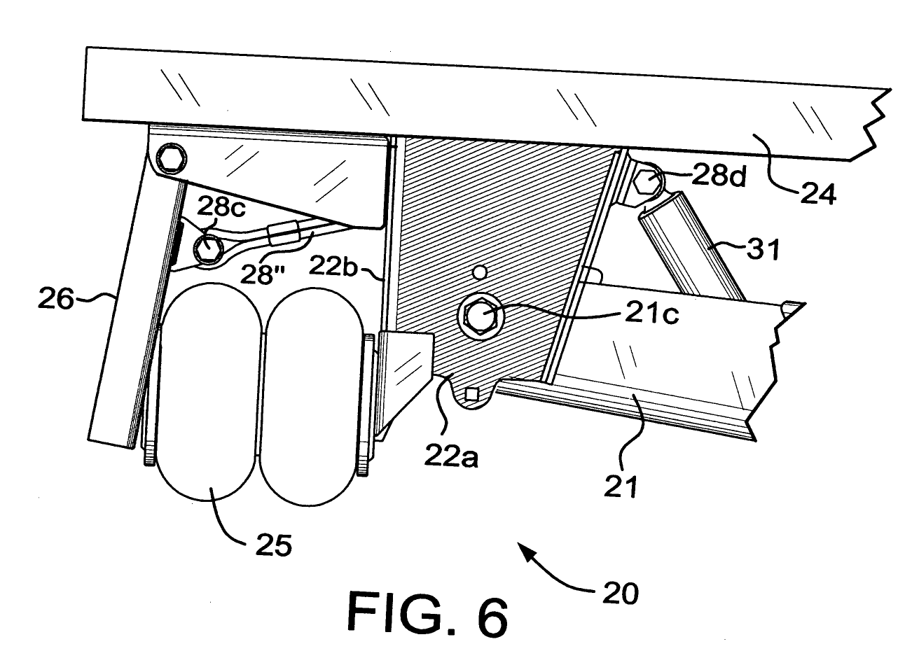

The hanger bracket 22 includes at least an outboard portion 22a (shown in FIG. 6), a forward portion 22b, and an inboard portion 22c that may be integrally formed or separately attached to one another. Depicted in FIGS. 1-6 is an embodiment of the present invention, where the outboard portion 22a and the inboard portion 22c are substantially parallel to one another, and the forward portion 22b is substantially perpendicular to the outboard portion 22a and the inboard portion 22c. Note that the outboard hanger bracket portion 22a is not shown in FIGS. 1-4 in order to show various items, like items 28, 28′, 28b, 28d, and 29, but the outboard hanger bracket portion 22a is illustrated in FIG. 6.

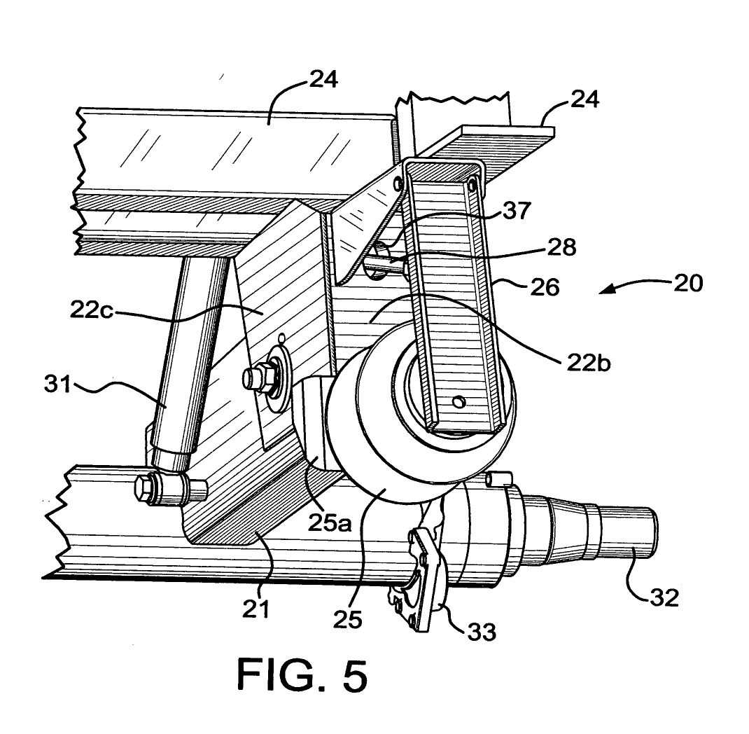

FIGS. 1, 5, and 6 show different views of a preferred embodiment of the pivotal attachment of the trailing arm 21 to the hanger bracket 22. FIGS. 1 and 6 depict the head of a bolt at a pivot point 21c, where the bolt extends through the hanger bracket 22 and the trailing arm 21. FIG. 5 depicts the end of the bolt extending through the hanger bracket 22c, where a nut is secured to the bolt.

Returning to FIG. 1, a horizontally oriented (i.e., substantially parallel to the frame member 24) air bag 25 is disposed at one end 25a to the forward hanger bracket portion 22b and the air bag 25 is disposed at another end 25b to a pivoting lever arm 26, by way of a contact point 27. The lever arm 26 is pivotally disposed on a lever bracket 35, which is disposed on the frame member 24.

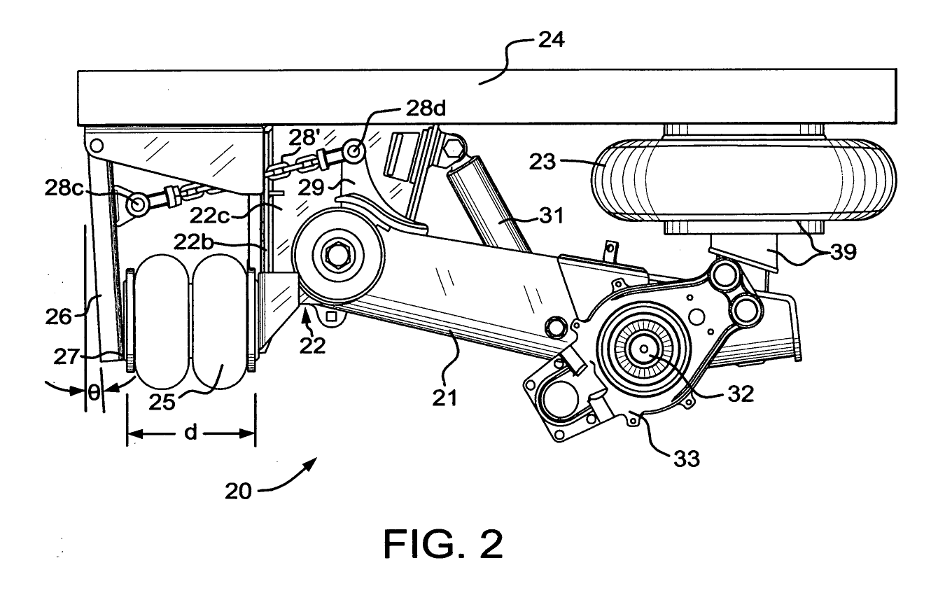

A link, which in one embodiment may be flexible member like a cable 28″ (as illustrated in FIG. 6) or a chain 28′ (as illustrated in FIG. 2), or in an alternative embodiment may be a rigid member 28 (see, for example, FIG. 1), is pivotally disposed at a first link end 28a, by way of a first link pivot 28c, to the lever arm 26. The link may also comprise the chain 28′ that is rigidly constructed.

The link 28 is pivotally disposed at a second end 28b, by way of a second link pivot 28d, to a flange member 29. In turn, the flange member 29 is disposed at the first end portion 21a of the trailing arm 21. Note that the link 28 may extend through a hanger bracket aperture 37, as shown in FIG. 5, and that the flange member 29 may be an integrally formed portion of the trailing arm 21.

A vertically oriented (i.e., substantially perpendicular to the frame member 24) air bag 23 (shown in an expanded/lowered position in FIG. 1) is disposed between the second end portion 21b of the trailing arm 21 and the frame member 24. Also shown in FIG. 1 is a mounting member 39 (for example, a piston or a pedestal) that is disposed between the air bag 23 and the second end portion 21b of the trailing arm 21.

FIG. 1 also illustrates a suspension shock absorber 31, an axle 32, and a wheel bracket 33. The shock absorber 31 is disposed at one end to the trailing arm 21 (as shown in FIG. 5) and at another end to the frame member 24. The axle 32 is also disposed on the trailing arm 21. The wheel bracket 33 is disposed on the axle 32.

Hence, at least the items 23, 31-33, and 39 cooperate with the air spring lift kit 20 of the present invention to connect one or more wheels/tires (not shown but common in the art) to the frame 24 of a vehicle (not shown). Although the present invention is particularly suited for a truck or trailer, it is within the spirit and scope of the present invention that the air spring lift kit 20 is also suited for any vehicle where an added suspension could be applied.

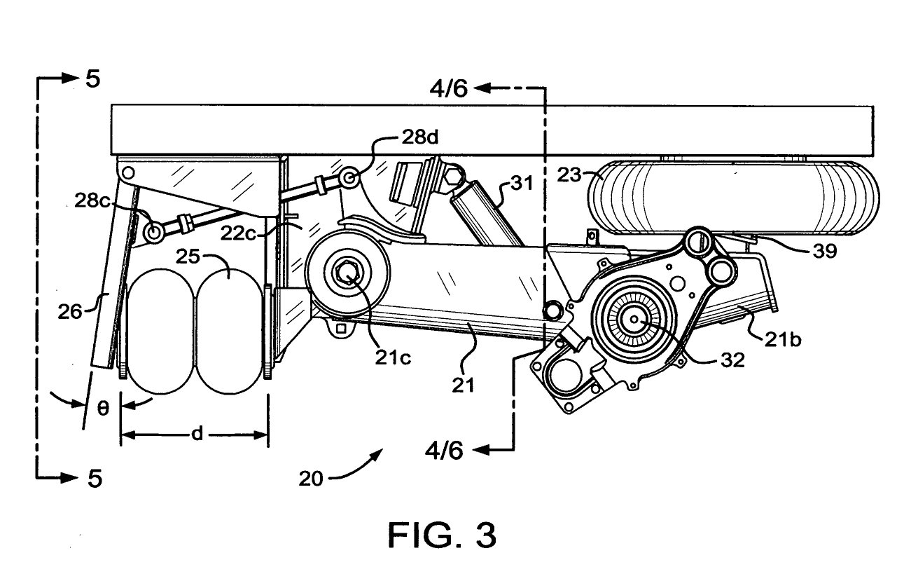

In the instant invention, when a load, which is deemed to be greater than the carrying capacity of the overall suspension of the vehicle in contact with the ground, is to be or has been added to the vehicle, then the air spring lift kit 20 may be moved from a raised position (see FIG. 2 or 3) to a lowered position (see FIG. 1). This results in the additional load being distributed on additional axles, wheels, and tires of the vehicle suspension 20. Thus, the present invention provides additional support to the vehicle for the added load.

In FIG. 2, the air spring lift kit 20 is in a nominally lifted position, where the horizontal air bag 25 has been expanded by the entry of pressurized air and where the vertical bag 23 (which does not participate in the lifting of the air spring lift kit 20) has been deflated by allowing air to exit the vertical bag 23.

A discovery of the present invention is demonstrated by comparing a transition between FIG. 1 and FIG. 2. Specifically, in going from the lowered position (FIG. 1) to the nominally raised position (FIG. 2), pressurized air is communicated to the horizontal air bag 25 and air is allowed to be released from the vertical air bag 23. The expansion of the horizontal air bag 25 results in the dimension “d” (defined to be the horizontal width of the horizontal air bag 25) becoming larger, the angle E) (defined to be the angle of extension of the lever arm 26 from a vertical center line position) approaching the vertical center line, the lever arm 26 rotating clockwise, and tension in the link 28, 28′, or 28″ being increased. As a result, the link 28-28″ forcibly pulls on the flange member 29, which in turn causes the trailing arm 21 to rotate counter-clockwise and compresses the shock absorber 31, thus raising the axle 32 and attached wheel(s) and tire(s).

FIG. 3 illustrates a more fully lifted (a.k.a., raised) embodiment of the present invention where the air bag 25 has been inflated more than the nominally raised embodiment of FIG. 2, thus the dimension “d” is greater than that of FIG. 2, the angle ) has crossed over the vertical center line, and the vertical air bag 23 has been compressed more than in the nominally lifted position. Thus, the lever 26 has pulled the trailing arm 21 into an almost horizontal position (with respect to the frame member 24). An advantage of this fully raised embodiment of the present invention is that it provides more clearance between the air spring lift kit 20 and a roadway (not shown).

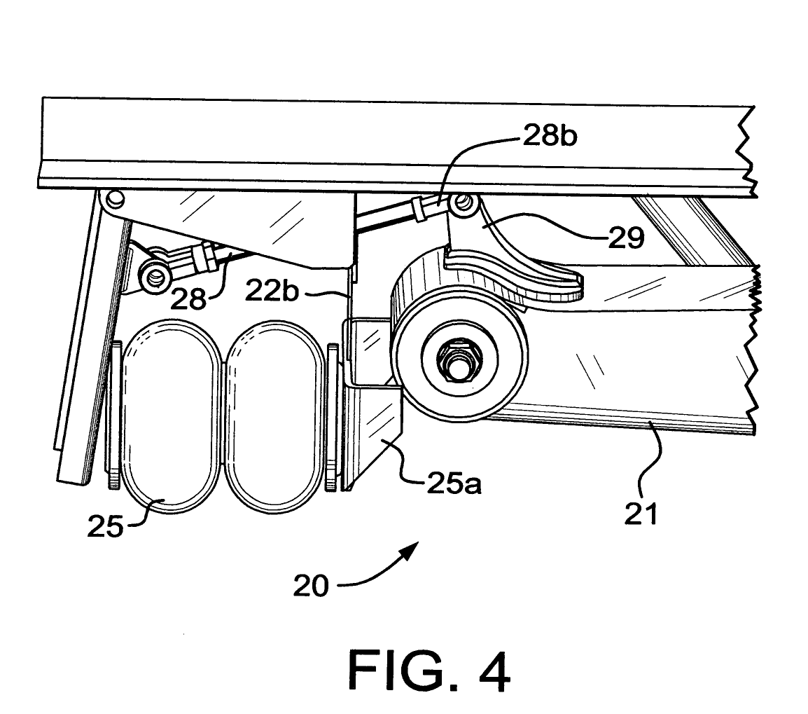

FIG. 4 illustrates the disposing, which may be by way of a welding, bolting, or integrally formed, of the flange member 29 on the trailing arm 21. Also, FIG. 4 shows the disposing, which may be by way of a welding or bolting, of the first horizontal bag end 25a to the forward hanger bracket portion 22b. The present invention is not limited by the disposing means utilized to join, to pivot, to connect, to form, or to attach the various elements of the instant invention.

To lower the air spring lift kit 20, a vehicle operator signals a solenoid(s) (not shown) to allow air to be released from the horizontally oriented air bag 25 and to communicate pressurized air to the vertical air bag 23 for expanding the vertical air bag 23. As a result, the weight of the trailing arm 21, the axle(s), and the wheel(s)/tire(s), and the expansion of the horizontal air bag 25 causes the air spring lift kit 20 to be lowered. Consequently, the tire(s) make contact with the ground. Thus, the vertically oriented air bag 23 and the shock absorber 31 provide added suspension support for the added load on the vehicle.

An advantage of the present invention, over much of the relevant art, is that the lifting force provided by the combination of the items 25, 26, 28, 29, and 21, during the raising of the air spring lift kit 20, is not dependent on the vertically oriented air bag 23 or a spring. As a result, the present invention is less complicated, light in weight, more compact, less costly, and easier to assemble and replace. In addition, the present invention provides more options for stowing the air spring lift kit 20.

As illustrated by contact point 27 in FIGS. 1-2, the horizontal air bag 25 raises the air spring lift kit 20 by simply pushing the lever arm 26. Therefore, there are no bushings to malfunction at the contact point 27, which results in minimal impact loading and fatigue during transportation in the lifted position. Thus, the present invention provides a more reliable, compact, lower weight, and a more air spring lift kit 20.

In accordance with the provisions of the patent statutes, the principles and modes of operation of this invention have been described and illustrated in its preferred embodiments. However, it must be understood that the invention may be practiced otherwise than specifically explained and illustrated without departing from its spirit or scope.

What is claimed is:

1. An air spring lift kit, comprising:
a trailing arm having an end portion, said end portion being pivotally disposed on a hanger bracket;
a horizontally oriented air bag disposed at one end to said hanger bracket and disposed at another end to a pivoting lever arm; and
a link having one end pivotally disposed on said lever arm and another end pivotally disposed on said trailing arm.

2. The air spring lift kit of claim 1, wherein said horizontally oriented air bag is substantially parallel to a frame member.

3. The air spring lift kit of claim 2, further comprising a vertically oriented air bag disposed between another end portion of said trailing arm and said frame member.

4. The air spring lift kit of claim 3, wherein said vertically oriented air bag is substantially perpendicular to said frame member.

5. The air spring lift kit of claim 4, wherein said vertically oriented air bag is disposed on said trailing arm by way of a mounting member.

6. The air spring lift kit of claim 5, wherein said mounting member comprises a piston.

7. The air spring lift kit of claim 1, wherein said link is pivotally disposed on said trailing arm by way of a flange member, said flange member disposed on said trailing arm at said end portion.

8. The air spring lift kit of claim 1, wherein said lever arm is pivotally disposed on a lever bracket, said lever bracket being disposed on said frame member.

9. The air spring lift kit of claim 1, further comprising a shock absorber disposed between said trailing arm and said frame member.

10. The air spring lift kit of claim 1, further comprising an axle, said axle being disposed on said trailing arm and said axle having a fully lifted position.

11. The air spring lift kit of claim 1, further comprising an axle, said axle being disposed on said trailing arm and said axle having a nominally lifted position.

12. The air spring lift kit of claim 1, further comprising an axle, said axle being disposed on said trailing arm and said axle having a lowered position.

13. The air spring lift kit of claim 1, wherein said link comprises a rigid member or a non-rigid member.

14. The air spring lift kit of claim 13, wherein said non-rigid member comprises a chain or a cable.

15. The air spring lift kit of claim 1, wherein said link comprises a chain constructed as a rigid member.

16. The air spring lift kit of claim 1, wherein said hanger bracket comprises an outboard portion, a forward portion, and an inboard portion, and said link extends from said lever arm to said flange member by passing through an aperture located through said forward portion of said hanger bracket.

17. A vehicle comprising said air spring lift kit of claim 1.

18. The vehicle of claim 17, wherein said vehicle comprises a dump truck or a trailer in a tractor-trailer combination.

19. A method of raising an air spring lift kit, comprising:
inflating a horizontally oriented air bag;
rotating a lever arm by way of said horizontally oriented air bag;
pulling on a link with said lever arm;
pulling on a trailing arm with said link; and
rotating said trailing arm into a raised position by way of said link.

20. A method of lowering a air spring lift kit, comprising:
compressing a horizontally oriented air bag;
rotating a lever arm in contact with said horizontal air bag;
lessening tension in a link pivotally disposed on one end to said lever arm and pivotally disposed on another end to a trailing arm; and
rotating said trailing arm into a lowered position.

21. The method of claim 20, further comprising expanding a vertically oriented air bag, thus supporting an added load of a vehicle.
